(19) United States
(12) Patent Application Publication
(10) Pub. No.: US 2014/0062339 A1
(43) Pub. Date: Mar. 6, 2014

(54) Lighting Device

(71) Applicant: iLight, LLC, Kaysville, UT (US)

(72) Inventors: Joshua James Wiscombe, Layton, UT (US); Gary Bret Millar, Highland, UT (US)

(73) Assignee: iLight, LLC, Kaysville, UT (US)

(21) Appl. No.: 14/012,957

(22) Filed: Aug. 28, 2013

Related U.S. Application Data
(60) Provisional application No. 61/694,170, filed on Aug. 28, 2012.

(51) Int. Cl. H05B 33/08

(52) U.S. Cl. CPC H05B 33/0842
USPC 315/307

(57) ABSTRACT

A technology is provided for communicating with a microprocessor that is powering a plurality of light emitting diodes (LEDs). Information bits may be received at a microprocessor circuit coupled to the plurality of LEDs. The microprocessor may be capable of receiving voltage from a voltage source. A code sequence may be identified using the information bits. The code sequence may be associated with an action to be performed with the plurality of LEDs. The code sequence may be decoded, at the microprocessor, so that the action can be performed with the plurality of LEDs.

### PRIORITY CLAIM

Priority is claimed to U.S. Provisional Application Ser. No. 61/694,170 filed Aug. 28, 2012, which is hereby incorporated herein by reference in its entirety.

### BACKGROUND

Indoor and outdoor lighting may be used for a variety of purposes. For example, decorative lighting may be popular during the holiday season and other times of the year. The decorative lighting may include a string of multiple lights. The decorative lighting may display numerous colors, such as red, blue and green. In addition, the decorative lighting may flash, dim, brighten, and blink according to a predefined setting.

As another example, the lighting may be included as part of a home automation system. For example, the home automation system may allow the indoor lighting to be controlled remotely. The lighting scheme (e.g., brightness, time of day when the lights are turned on and off) may be customized to save electricity and increase the lifetime of the light bulbs.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a light emitting diode (LED) bulb according to an example of the present technology.

FIG. 2 is a system for communicating with a power microprocessor that is powering a plurality of light emitting diodes (LEDs) according to an example of the present technology.

FIGS. 3A and 3B are sinusoidal and square voltage waveforms received at a microprocessor according to an example of the present technology.

FIG. 4 is a block diagram of a zone controller system for controlling a plurality of light emitting diodes (LEDs) according to an example of the present technology.

FIG. 5 is a more detailed circuit diagram of the zone controller for powering a plurality of light emitting diodes (LEDs) according to an example of the present technology.

FIGS. 6-14 are tables displaying sequence codes that can be used by a microprocessor to control a plurality of light emitting diodes (LEDs) according to an example of the present technology.

FIG. 15 is a flowchart of an example method for communicating with a microprocessor that is powering a plurality of light emitting diodes (LEDs) using computer circuitry.

FIG. 16 is a flowchart of another example method for communicating with a microprocessor that is powering a plurality of light emitting diodes (LEDs) using computer circuitry.

### DETAILED DESCRIPTION

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

A technology is described for communicating with a power microprocessor that is powering at least one LED (e.g., three LEDs may be used) in an LED light bulb. The power microprocessor may power a plurality of light emitting diodes (LEDs). The LEDs may be powered using a unconditioned and half-wave rectified power from a power line and the instructions for controlling the behavior of the LEDs (Light Emitting Diodes) may be sent across a power line network (e.g., the power line network in a home or business) to the power microprocessor. In addition, the LEDs may be included in a decorative lighting system, home lighting system, or a home automation system.

In one example, the power microprocessor may be capable of receiving an unconditioned voltage from a voltage source. For example, the unconditioned voltage may be provided in the form of alternating current (AC). An AC voltage being received at the microprocessor may be represented as half-wave rectified and smoothed sinusoidal waveform.

In one configuration, the power microprocessor may receive instructions from a communications microprocessor across a power line network in the form of information bits when communicating with other elements. For example, the power microprocessor may receive information bits that include a string of “0s” and “1s”. The power microprocessor may identify a code sequence from the string of “0s” and “1s”. The code sequence may be associated with an action to be performed with the LEDs. For example, a particular code sequence may be associated with: the LEDs turning off, the LEDs turning on, the LEDs being dimmed, the LEDs being brightened, the color of the LEDs being changed, etc. The power microprocessor may decode the code sequence to identify the type of action that is associated with the code sequence and then perform the action represented by the code sequence with the LEDs. For example, the power microprocessor may receive a string of information bits and zero bits of “110010011.” The power microprocessor may determine that “110010011” is a code sequence associated with turning off the LEDs. The power microprocessor may then use the code sequence of “110010011” and turn off the LEDs.

In one configuration, the power microprocessor may receive the information bits when the AC voltage being received at the microprocessor is being suppressed by a communication microprocessor. For example, the power microprocessor may receive each information bit when a half cycle of the sinusoidal waveform is suppressed. When the half cycle is suppressed, the voltage being received at the microprocessor may be prevented from substantially exceeding zero volts.

In one configuration, the half cycles in the voltage may be suppressed using a Triode for Alternating Current (TRIAC) coupled to the power microprocessor. When the half cycle is suppressed, the power microprocessor may receive an information bit of “1.” In addition, the microprocessor may receive a “0” (i.e., a zero bit) when the voltage is being received at the microprocessor. The combination of “0s” and “1s” may form the code sequence. The power microprocessor may decode the code sequence to perform the action associated with that code sequence (e.g., turning off the LEDs, turning on the LEDs, dimming the LEDs, brightening the LEDs, changing the color of the LEDs, etc.)

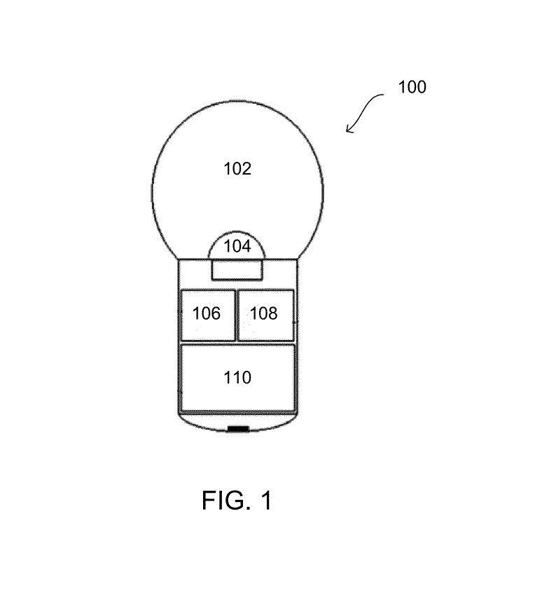

FIG. 1 illustrates an example of a light emitting diode (LED) bulb 100. The LED bulb 100 may be included in the string of multiple light bulbs (e.g., Christmas lights) or used as a single stand-alone light bulb. Alternatively, the LED bulb 100 may be included in a home, office building, etc. The LED bulb 100 may have an unconditioned power circuit that may be powered from an alternating current (AC) wiring outlet in the home or office building. The AC wiring outlet may supply 100/110 volts, 240 volts, etc. In one configuration, the CPU 108 or power microprocessor associated with the LED bulb 100 may receive instructions over the AC wiring, such as instructions to turn off, turn on, dim, brighten, change color, etc. In one example, the power microprocessor associated with the LED bulb 100 may receive the instructions using a power line communications (PLC) protocol from a communications processor.

The LED bulb 100 may include a lighting area 102 that is composed of a polycarbonate plastic with a frosted finish. The lighting area 102 may be spherical, cylindrical, triangular, cubical, conical, etc. Alternatively, the lighting area 102 may be composed of various materials, such as plastic, glass, etc.

The LED bulb 100 may include a light source 104. In one example, the light source 104 may be at least one light emitting diode (LED). The LED may include a red light emitting diode, a green light emitting diode, and a blue light emitting diode. In other examples, the light source 104 may include electron stimulated luminescence (ESL) light bulbs, incandescent lamps (e.g., halogen lamps), electroluminescent (EL) lamps (e.g., LEDs, light-emitting electrochemical cells), gas discharge lamps (e.g., fluorescent lamps, induction lighting, neon lamps, argon lamps), high-intensity discharge lamps, etc.

In one example, the LED bulb 100 may include a power line communications (PLC) module or circuit 106. The PLC 106 may allow a central processing unit (CPU) 108 or power microprocessor included in the light bulb 100 to connect to the AC wiring to receive communication signals. In addition, the CPU 108 or power microprocessor 108 may be included on a circuit board with the LED(s) 104. The terms CPU and power microprocessor may be used interchangeably in this discussion of FIG. 1. As a result, the LED bulb 100 with the power line communication (PLC) may be employed in home automation systems or decorative lighting systems that use household electrical wiring for communication. The PLC 106 may isolate the AC power line from the control circuitry, as well as filter transit electrical noise.

As mentioned earlier, the LED bulb 100 may include a central processing unit (CPU) 108 or power microprocessor. The CPU 108 may control a color and/or brightness level associated with the LED bulb 100 by controlling the timing and amounts of power sent to the LEDs. In addition, the CPU 108 may store lighting settings and process signals received via the PLC 106. The CPU 108 may include: an oscillator to control clock timing, an input-output (I/O) port to control the LED bulb 100 and receive signals from the PLC 106, and an Electrical Erasable Programmed Read Only Memory (EEPROM) to store lighting settings.

In one example, the EEPROM may store the lighting settings even in the absence of power. The CPU 108 may include functionality to control the pulse width modulation (PWM) of the LEDs in the light source 104. In other words, the microcontroller may control the brightness level and the color produced at the light source 104 by controlling the duty cycle and strength of the power sent to each LED in the light source 104. The number of colors and brightness may be increased or decreased based on the information communicated to the microprocessor. In addition, the microcontroller may process the signals received via the PLC 106 to enable control of the LED bulbs 100.

The LED bulb 100 may include a power unit 110. In one example, the power unit 110 may convert the AC voltage (e.g., 110-120 AC voltage) to a regulated direct current (DC) output. For example, the 120 volts may be stepped down to 12 volts. The 12-volt

AC voltage may be fully rectified to produce 12 volts DC. The 12 volts DC may be regulated to produce 5 volts DC. The 5 volts DC may be filtered for transit electrical noise producing clean 5 volt DC, 130 milliamps (mA) output. Alternatively, the power unit may provide a half wave rectification that is smoothed and limited to a specific voltage range. In this case, the voltage can be considered an unconditioned voltage with which the CPU (i.e., the microprocessor) is able to operate.

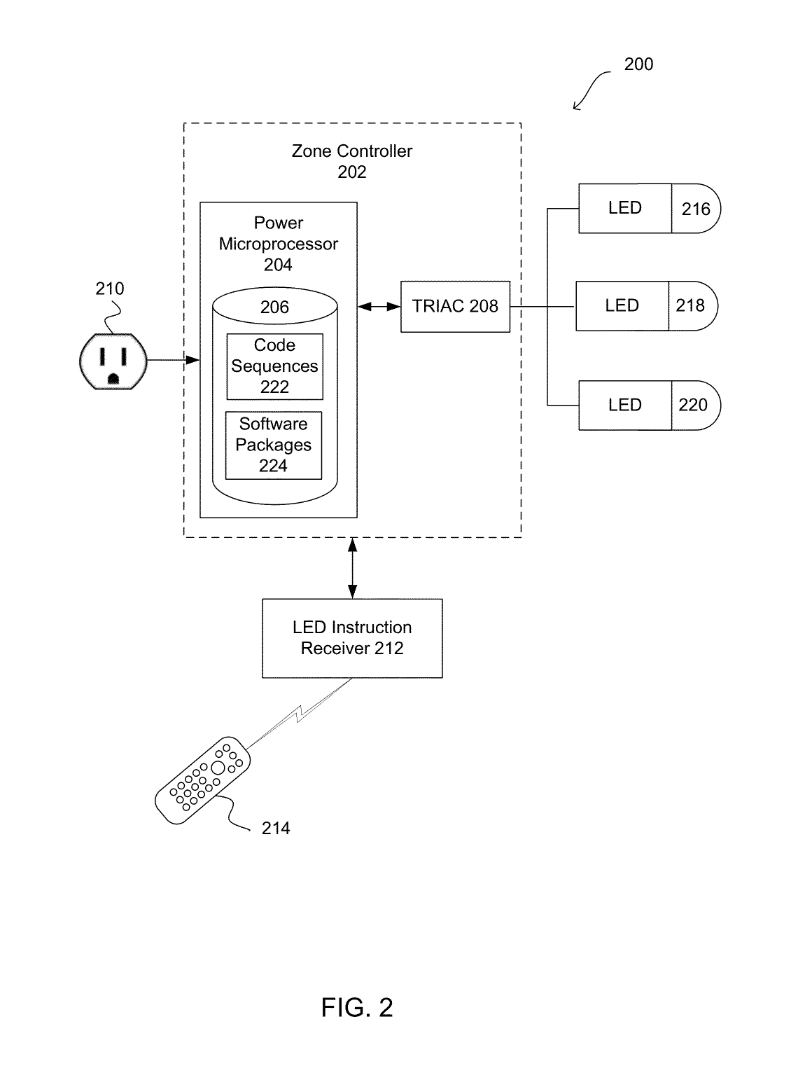

FIG. 2 illustrates a system 200 for communicating with a communications microprocessor 204 that is controlling a plurality of light emitting diode (LED) bulbs 216, 218 and 220. The communications microprocessor 204 may send communications and codes for controlling the LED bulbs using a power line network. In one configuration, the communications microprocessor 204 may be included in a zone controller 202. In addition, the communications microprocessor 204 may receive a voltage (e.g., 0 to 5 volts DC), or AC power, from a voltage source 210.

The communications microprocessor 204 may use the power line communications to perform a number of actions with the LED bulbs based on the instructions sent over the power line network to LED bulbs. For example, the communications microprocessor 204 may send messages to turn off the LEDs, turn on the LEDs, dim the LEDs, brighten the LEDs, change the color of the LEDs, etc. In one example, the communications microprocessor 204 may send the message to perform the action with a single LED bulb in the plurality of LED bulbs (e.g., LED bulb 216), a portion of the plurality of LED bulbs s (e.g., LED bulb 216 and LED bulb 218), or the plurality of LED bulbs coupled to the communications microprocessor 204 (e.g., LED 216, LED 218 and LED 220). The actions may also include increasing or decreasing the wattage used to power the LED bulbs.

In order to perform the actions with the LED bulbs, the communications microprocessor 204 may run various software packages 224. The software packages 224 may, for example, monitor the amount of light in a room, adjust the amount of light produced by the LED bulbs to a defined wattage (e.g., 40 watts), or measure the amount of sunlight coming into the room and determining the amount of light to be produced by the LED bulbs for maintaining a steady lighting level in the room (e.g., a steady 40 watts of illumination).

In one configuration, the software packages 224 may be stored in a data store 206. The term “data store” may refer to any device or combination of devices capable of storing, accessing, organizing, and/or retrieving data. The data store 206 may be included in the communications microprocessor 204. The data store 206 may include volatile or non-volatile read-only memory (ROM), erasable programmable read only memory (EPROM), electrically erasable programmable read-only memory (EEPROM), or flash memory.

An LED instruction receiver 212 may receive instructions from a remote control 214 to perform an operation with the LED bulbs (e.g., change the color of the LED bulbs, dim a particular LED bulb). In one example, the LED instruction receiver 212 may receive the instructions from a mobile phone, tablet computer, etc. The LED instruction receiver 212 may associate a code sequence with the instruction. In addition, the LED instruction receiver 212 may communicate the code sequence to the communications microprocessor 204. In one example, the LED instruction receiver 212 may communicate the code sequence using a wireless router, a universal serial bus (USB) port, or another radio frequency (RF) network.

The communications microprocessor 204 may receive the code sequence associated with the instruction in the form of “0s” and “1s”. In other words, the code sequence may be comprised of a combination of information bits (i.e., “1” bits) and zero bits. For example, the communications microprocessor 204 may receive an 8-digit code sequence for the instruction of blinking a particular LED bulb in a string of LED bulbs. In one configuration, the communications microprocessor 204 may receive a part of the code sequence when the voltage being provided to the communications microprocessor 204 is being suppressed. The power voltage may be temporarily suppressed during one or more half cycles of a sinusoidal waveform. A sinusoidal waveform may represent the AC voltage being provided to the communications microprocessor 204. In addition, the half cycle of the sinusoidal waveform may be suppressed so that the voltage does not substantially exceed zero volts during that half cycle.

In one configuration, the communications microprocessor 204 may be coupled to a Triode for Alternating Current (TRIAC) 208. The TRIAC may conduct current in either direction when it is triggered (turned on). The TRIAC may also be known as a bidirectional triode thyristor or bilateral triode thyristor. The TRIAC 208 may be used to suppress the half cycles of the AC power so that the communications microprocessor 204 can receive the information bits indicating the code sequence during the suppressed half cycles of the sinusoidal waveform.

The communications microprocessor 204 may identify the code sequence from the information bits (i.e., the “1” bits) and the zero bits (i.e., the “0s”). For example, the communications microprocessor 204 may receive “00001100100110000” and identify that the sequence “110010011” is a code sequence for performing a particular action with the LED bulbs. The communications microprocessor 204 may decode the code sequence to determine the particular action to perform with the LED bulbs. As an example, the communications microprocessor 204 may determine that the code sequence “110010011” corresponds to the action of turning off the LED bulbs. Further, the communications microprocessor 204 may compute a checksum or a hash sum for detecting errors in the code sequence. Thus, the checksum may be used to verify that the code sequence is an authentic code sequence with an associated LED bulb action.

In one configuration, the communications microprocessor 204 may decode the code sequence using a list of code sequences 222 that may be received at the communications microprocessor 204. The list of code sequences 222 may include the LED bulb actions associated with the code sequences. For example, the code sequences 222 may associate the action of turning off the LED bulbs with the code sequence of “110010011.” The communications microprocessor 204 may determine the action to perform with the LED bulbs after identifying the sequence code in the list of possible sequence codes. In one example, the list of code sequences 222 may be stored in the data store 206.

In another configuration, the LED bulbs 216, 218 and 220 may include a power microprocessor (not shown in FIG. 2 but as 108 in FIG. 1) for processing the signals received from the communications microprocessor 204. In other words, the LED bulbs may process instructions from the communications microprocessor 204 using the power microprocessor for performing the action associated with the code sequence. In one example, the LED bulbs may receive the signals over the communication power line.

In one example, the communications microprocessor 204 may send a synchronization signal to the LED bulbs 216, 218 and 220. Thus, the LED bulbs 216, 218 and 220 may be synchronized so that the LED bulbs 216, 218 and 220 may operate in a synchronous manner.

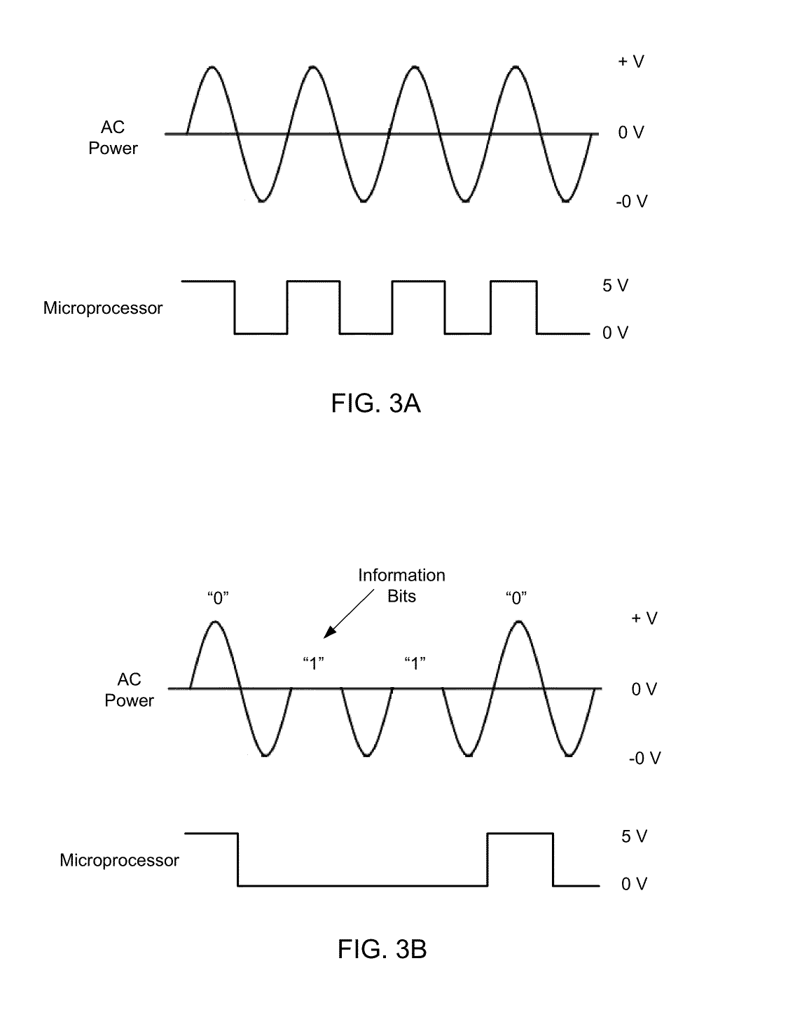

FIGS. 3A and 3B are example sinusoidal waveforms received at a microprocessor and a square wave representing how the microprocessor interprets these sinusoidal waveforms. As shown in FIG. 3A, the alternating current (AC) power may follow a sinusoidal waveform and range from +V to −V. The AC power may be delivered at 60 Hertz (Hz), so that each half wave may be 1/120^{th} of a second. The voltage read by the microprocessor may vary depending on the AC power. For example, the voltage at the microprocessor may be at substantially zero volts when the AC power is negative. When the AC power crosses the zero voltage level (i.e., a “zero crossing” where the AC power goes from a negative voltage level to a positive voltage level, or vice versa), the voltage at the microprocessor may become a positive level (e.g., 5 volts).

FIG. 3B illustrates the sinusoidal waveform with suppressed portions. The suppressed portions may be used to communicate information bits to the microprocessor. In one example, the sinusoidal waveform being received at the microprocessor may be suppressed using a TRIAC. The AC power may substantially zero volts when the half cycles are suppressed. In addition, the voltage at the microprocessor may be substantially zero volts when the half cycles are suppressed. In other words, suppressing the half cycles may prevent the AC power from reaching a positive voltage level, so the voltage at the microprocessor remains at substantially zero volts. When the half cycles are not being suppressed and the AC voltage reaches a positive voltage level, the voltage at the microprocessor may become a positive level (e.g., 5 volts).

FIG. 3B illustrates the microprocessor receiving “0110” while the half cycles of the sinusoidal waveform are being suppressed or not suppressed. As previously discussed, when the half cycles of the sinusoidal waveform are suppressed, the information bits of “1” may be communicated to the microprocessor. When the half cycles of the sinusoidal waveform are not suppressed, zero bits (or “0s”) may be communicated to the microprocessor. The microprocessor may identify a code sequence from the plurality of “0s” and “1s” and perform an action with the LED bulbs using the code sequence.

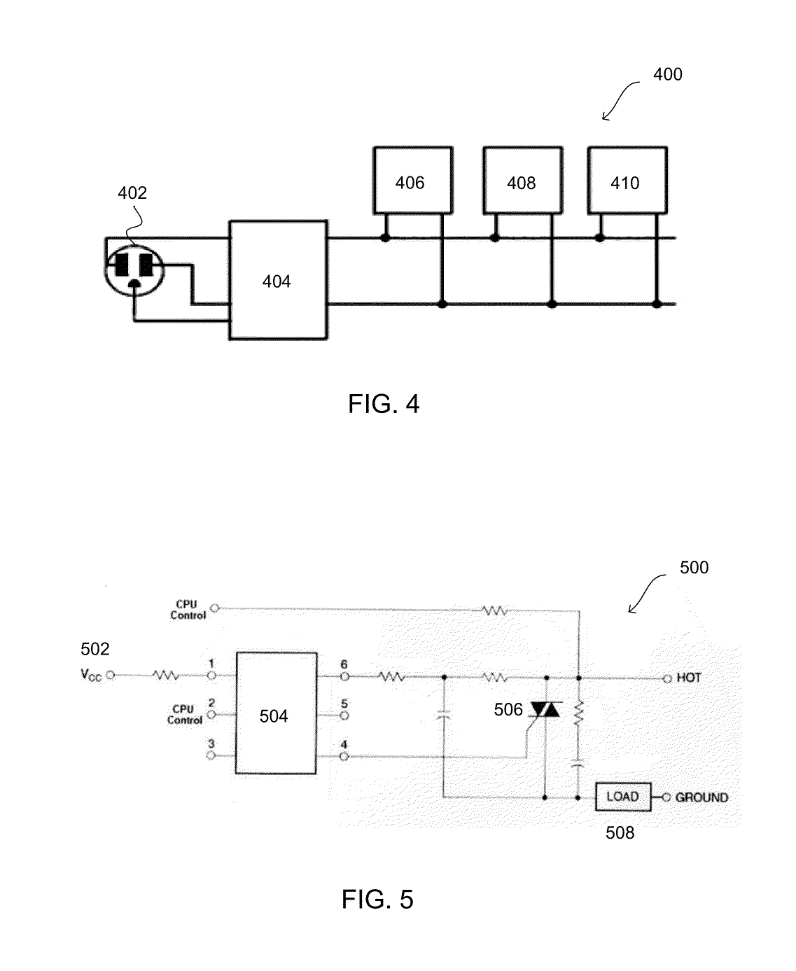

FIG. 4 is a block diagram of a zone controller system 400 for controlling a plurality of light emitting diodes (LED bulbs). A zone controller 404 may be connected to a plurality of LED bulbs, such as 406, 408 and 410. Thus, the zone controller 404 may be connected to the LED bulbs in a home or building. The zone controller 504 may include a communications microprocessor for controlling the LED bulbs. The zone controller 404 may receive AC power from a power source 402. For example, the zone controller 504 may be connected to a 110-volt outlet. The 110-volt electrical wiring may provide power to the LED bulbs, as well as a communication link between the zone controller 404 and the LED bulbs. Thus, the zone controller 404 may receive information on controlling a specific LED bulb (e.g., LED bulb 506) or LED bulbs via the PLC link. Each of the LED bulbs may contain a circuit to receive AC power for the LEDs in the LED bulbs and half-wave rectification and smoothing for powering the power microprocessor in an LED bulb.

FIG. 5 is an example circuit diagram 500 of a zone controller for communicating with and controlling a plurality of light emitting diodes (LED bulbs). The circuit diagram 500 may receive AC power at Vcc 502. The circuit 500 may include a communication microprocessor 504, a TRIAC 506, a load element 508, and a plurality of resistors and/or capacitors. The communications microprocessor 504 may send a plurality of information bits by suppressing one or more half cycles in a voltage being sent via the hot line. In particular, the TRIAC 506 may suppress the half cycles in the conditioned voltage. The communications microprocessor 504 may identify a code sequence containing information bits and then send the code sequence.

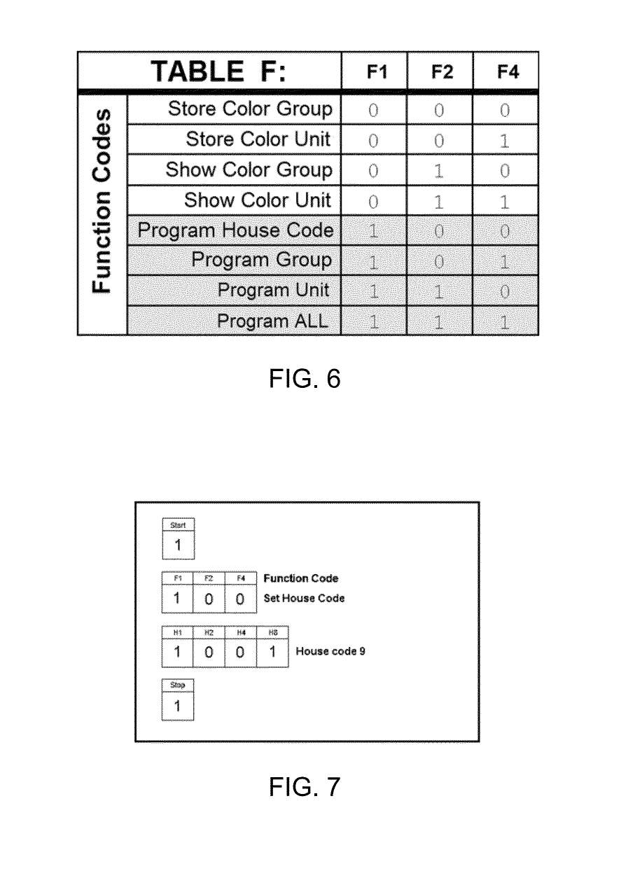

FIGS. 6-14 are exemplary tables that display sequence codes. The sequence codes can be received by a communications microprocessor to identify functions that are to be performed with a plurality of light emitting diodes (LED bulbs). Each LED bulb may be addressed by using a house code, a group code, or an individual LED bulb unit code. The individual LED bulb may be communicated with using a sequence code. The sequence code may begin with a start bit (e.g., a “1”) and end with a stop bit (e.g., a “1”). In one example, the LED bulb may be assigned an address that is used to communicate with that particular LED bulb.

FIG. 6 illustrates a plurality of function codes that may be used by the LED bulbs. The function codes may be used to assign a complete address code to the LED bulbs or the house and group and unit codes to the LED bulbs.

FIG. 7 illustrates an example function code for programming a house code. As a result, any LED bulb plugged into a power line network may be programmed to the house code (e.g., house code 9).

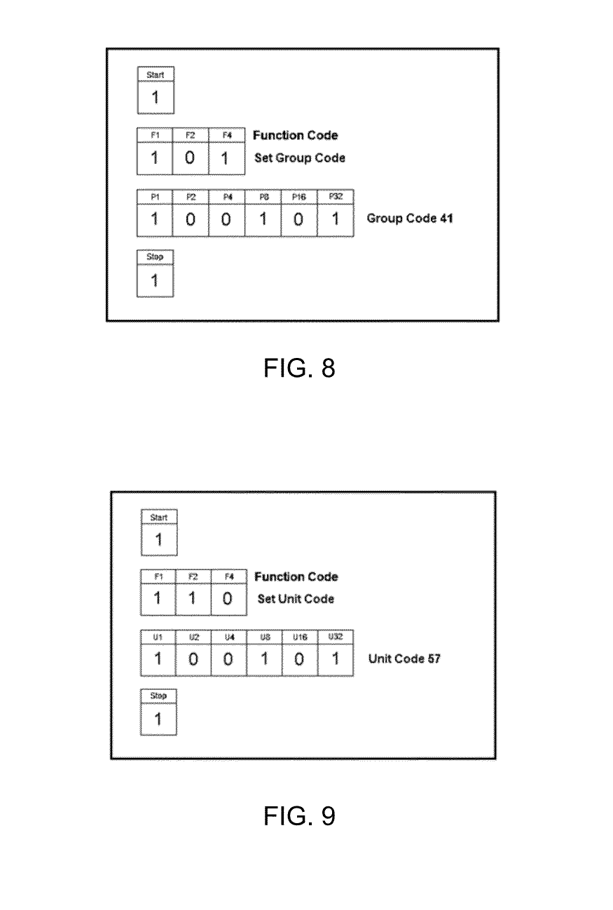

FIG. 8 illustrates an example function code for programming a group code. As a result, any LED bulb in a zone that is plugged into a power line network may be programmed to the group code (e.g., group code 41).

FIG. 9 illustrates an example function code for programming a unit code. As a result, any LED bulb plugged into a power line network may be programmed to the unit code (e.g., group code 57). In addition, when addressing the LED bulbs in a unit mode, both the unit and group codes may be used as the address.

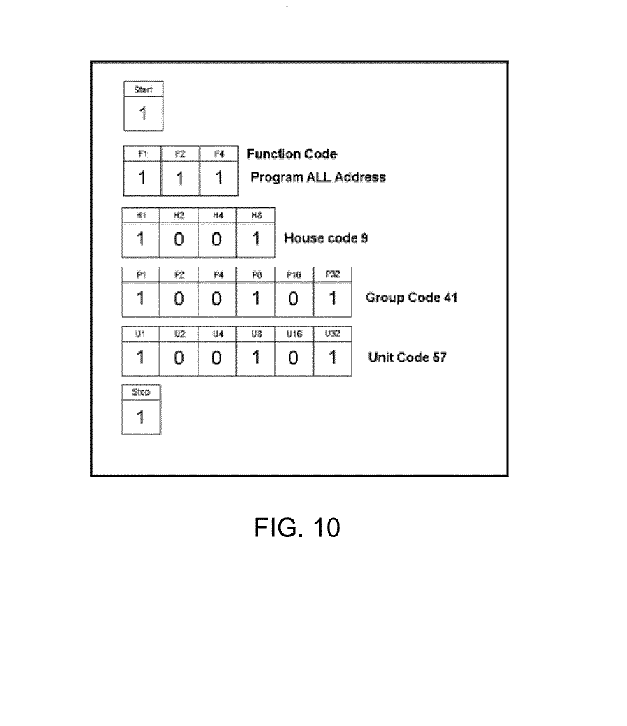

FIG. 10 illustrates an example function code for programming a unit code. As a result, the LED bulbs may be programmed with the house code, the group code, and the unit code.

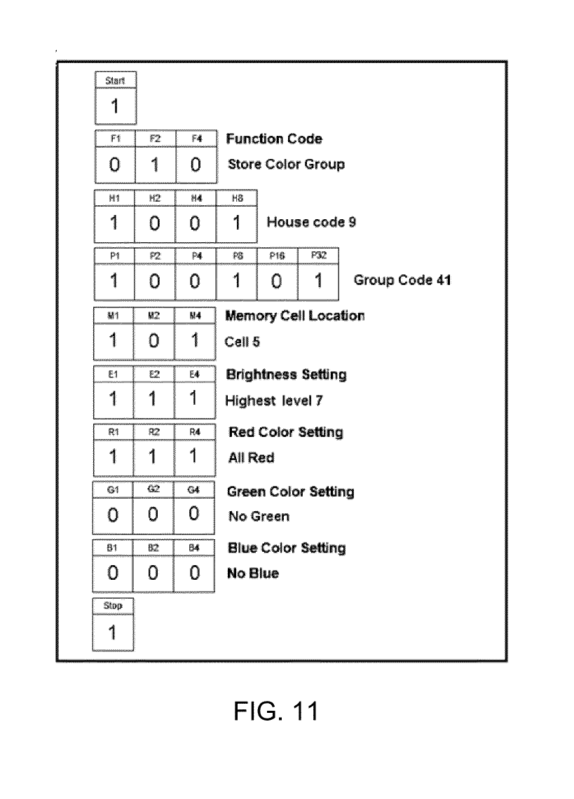

FIG. 11 illustrates an example function code for programming the LED bulbs to a set color and brightness using one of eight memory cells specified by a group value. In one example, each LED bulb may allow eight programmable color settings. With 512 colors and 8 various settings of brightness, 4096 color and brightness combinations may be allowed. When the LED bulb is programmed to the set color and brightness, the color that is being displayed may not change because the LED bulb may be configured to display a stored color.

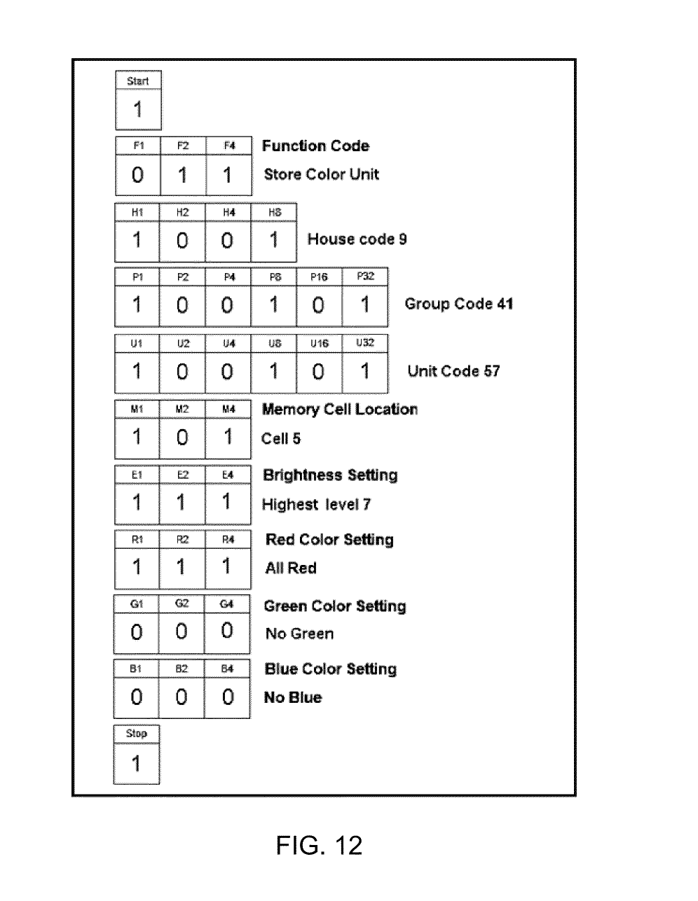

FIG. 12 illustrates an example function code for programming the LED bulbs to a set color and brightness using one of eight memory cells at a location specified by the unit value and the group value. When an LED bulb is programmed to the set color and brightness, the color that is being displayed may not change because the LED bulb may be configured to display a stored color.

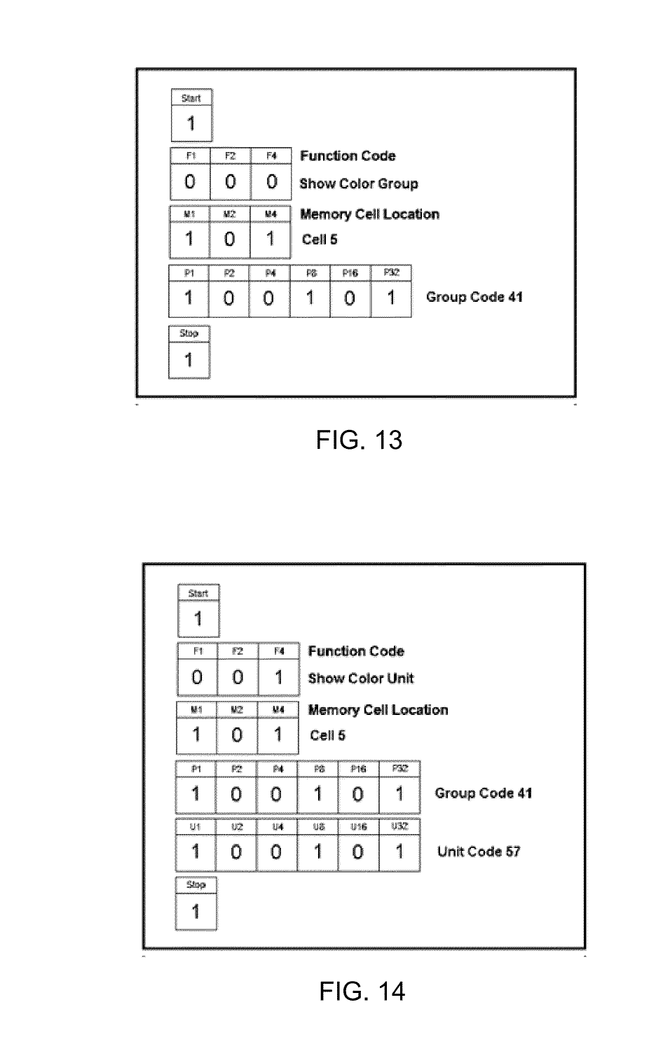

FIG. 13 illustrates an example function code for the LED bulb to display stored values (i.e., values stored in memory) at the location specified by the group value. In this example function code, no function codes are programmed into the memory of the LED bulb.

FIG. 14 illustrates an example function code for the LED bulb to display stored values (i.e., values stored in memory) at the location specified by the group value and the unit value. In this example function code, no function codes are programmed into the memory of the LED bulb.

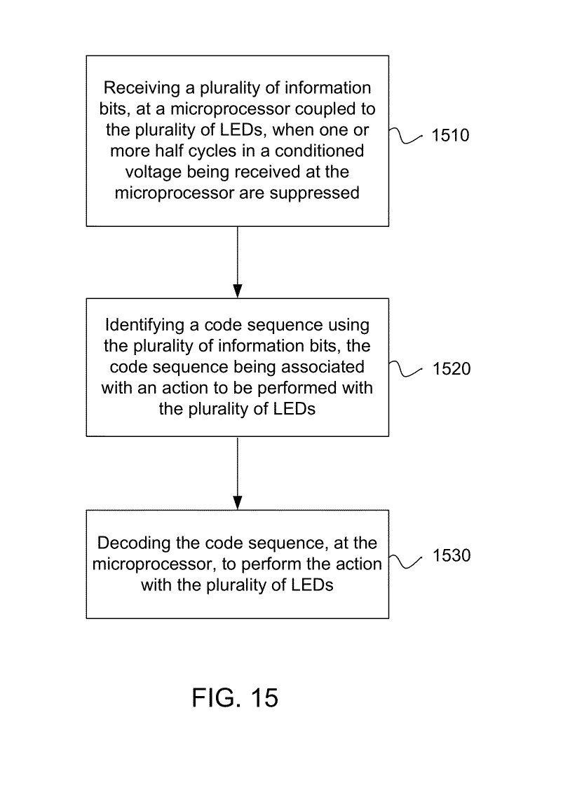

FIG. 15 is a flowchart of an example method for communicating with a microprocessor that is powering a plurality of light emitting diodes (LEDs). A plurality of information bits are received at a microprocessor coupled to the plurality of LEDs, as in block 1510. The microprocessor may receive the plurality of information bits when one or more half cycles in an unconditioned AC voltage being received at the microprocessor are suppressed. In one example, the half cycles in the unconditioned voltage may be suppressed using a Triode for Alternating Current (TRIAC) coupled to the communication microprocessor. In addition, the half cycles in the unconditioned AC voltage may be suppressed from reaching a positive unconditioned voltage level. In one configuration, the plurality of LEDs may be powered by the microprocessor in a home or business automation system.

A code sequence may be identified using the plurality of information bits, as in block 1520. The code sequence may be associated with an action to be performed with the plurality of LEDs. The action may be selected from a group consisting of: turning on the LEDs, turning off the LEDs, dimming the LEDs, brightening the LEDs, and changing a color associated with the LEDs. In addition, the code sequence may include a plurality of “0s” and “1s.” The “0s” may be received when the microprocessor is receiving voltage and the “1s” may be included in the information bits received at the microprocessor when the half cycles in the voltage being provided to the microprocessor are suppressed.

The code sequence may be decoded at the microprocessor to perform the action with the plurality of LEDs, as in block 1530. The code sequence may be decoded to determine the action associated with that code sequence. For example, the microprocessor may receive a code sequence of “110010011” and decode the code sequence to determine the action to be performed with the LEDs that is associated with the code sequence.

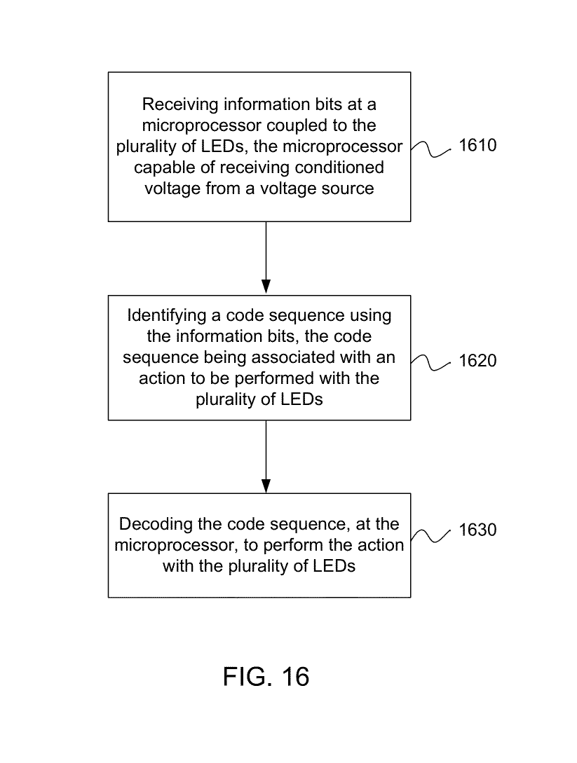

FIG. 16 is a flowchart of another example method for communicating with a microprocessor that is powering a plurality of light emitting diodes (LEDs). In one configuration, the plurality of LEDs may be included in a home automation system. For example, the home automation system may allow the LEDs to be automatically controlled depending on the user's lighting preference (e.g., softer lighting for elegant dining, bright lights for a festive gathering). In addition, the LEDs may be controlled using power line communication (PLC). The power link network may be part of a home or business.

A plurality of information bits may be received at a microprocessor coupled to the plurality of LEDs, as in block 1610. The microprocessor may be capable of receiving conditioned or unconditioned voltage from a voltage source. In one example, the information bits may be received using one or more suppressed half cycles in the voltage being received at the microprocessor. The half cycles in the voltage may be suppressed from reaching a positive voltage level. In one example, the half cycles in the voltage may be suppressed using a Triode for Alternating Current (TRIAC) coupled to an instruction microprocessor.

A code sequence may be identified using the information bits, as in block 1620. The code sequence may include a plurality of “0s” and “1s.” The “0s” may be received when the microprocessor is receiving the voltage and the “1s” may be included in the information bits received at the microprocessor when the half cycles in the voltage being provided to the microprocessor are suppressed. The code sequence may include at least one code selected from a group including: a start code, a function code, an address code, and a stop code.

The code sequence may be associated with an action to be performed with the plurality of LEDs. The action may be selected from a group including: turning on the LEDs, turning off the LEDs, dimming the LEDs, brightening the LEDs, and changing a color of the LEDs. In one example, the microprocessor may perform actions with specific LEDs using an address associated with the LED.

The code sequence may be decoded at the microprocessor, as in block 1630. In addition, the code sequence may be validated as an authentic code sequence using a checksum. The microprocessor may perform the action with the plurality of LEDs using the code sequence. In other words, the microprocessor with the bulb may perform the action (e.g., changing the color of the LEDs) that is associated with the decoded code sequence.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the technology. One skilled in the relevant art will recognize, however, that the technology can be practiced without one or more of the specific details, or with other methods, components, materials, etc. In other instances, well-known structures, materials, or operations are not shown or described in detail to avoid obscuring aspects of the technology.

While the foregoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1. A method of communicating with a microprocessor that is powering a plurality of light emitting diodes (LEDs), the method comprising:
receiving a plurality of information bits, at the microprocessor coupled to the plurality of LEDs, when one or more half cycles in an alternating current (AC) voltage being received at the microprocessor are suppressed;
identifying a code sequence from the plurality of information bits, the code sequence being associated with an action to be performed with the plurality of LEDs; and
decoding the code sequence, at the microprocessor, to perform the action with the plurality of LEDs.

2. The method of claim 1, wherein the action is selected from a group consisting of:
turning on the LEDs, turning off the LEDs, dimming the LEDs, brightening the LEDs, and changing a color associated with the LEDs.

3. The method of claim 1, wherein the code sequence comprises a plurality of “0s” and “1s,” wherein the “0s” are received when the voltage is received at the microprocessor and the “1s” are received in the information bits when the half cycles in the voltage are being suppressed.

4. The method of claim 1, wherein the half cycles in the voltage are suppressed using a Triode for Alternating Current (TRIAC) coupled to the microprocessor.

5. The method of claim 1, wherein the half cycles in the voltage are suppressed from reaching a positive voltage level.

6. The method of claim 1, further comprising powering the plurality of LEDs in a home automation system.

7. A method of communicating with a microprocessor that is powering a plurality of light emitting diodes (LEDs), the method comprising:
receiving a plurality of information bits at the microprocessor coupled to the plurality of LEDs, the microprocessor capable of receiving voltage from a voltage source;
identifying a code sequence from the information bits, the code sequence being associated with an action to be performed with the plurality of LEDs; and
decoding the code sequence, at the microprocessor, to perform the action with the plurality of LEDs.

8. The method of claim 7, further comprising receiving the information bits when one or more half cycles in the voltage being received at the microprocessor are suppressed.

9. The method of claim 8, wherein the half cycles in the voltage are suppressed from reaching a positive voltage level.

10. The method of claim 7, wherein the action is selected from a group consisting of:
turning on the LEDs, turning off the LEDs, dimming the LEDs, brightening the LEDs, and changing a color of the LEDs.

11. The method of claim 7, wherein the code sequence comprises a plurality of “0s” and “1s,” wherein the “0s” are received when the voltage is received at the microprocessor and the “1s” are received in the information bits when half cycles in the voltage are being suppressed.

12. The method of claim 8, wherein the half cycles in the voltage are suppressed using a Triode for Alternating Current (TRIAC) coupled to the microprocessor.

13. The method of claim 8, further comprising validating the code sequence using a checksum.

14. The method of claim 7, wherein the code sequence includes at least one code selected from a group consisting of: a start code, a function code, an address code, and a stop code.

15. The method of claim 7, wherein the plurality of LEDs are included in a home automation system.

16. The method of claim 7, further comprising powering the plurality of LEDs using a power line network.

17. A system for communicating with a power microprocessor that is powering a plurality of light emitting diodes (LEDs), the system comprising:
the power microprocessor configured to receive a plurality of information bits when one or more half cycles in a voltage being received at the power microprocessor are suppressed, the power microprocessor identifying a code sequence using the plurality of information bits;
a Triode for Alternating Current (TRIAC) configured to suppress the half cycles in the voltage being received at the power microprocessor, the TRIAC being coupled to the power microprocessor; and
the plurality of LEDs configured to perform an action in response to the power microprocessor identifying the code sequence and performing the action with the plurality of LEDs based on the code sequence.

18. The system of 17, wherein the plurality of LEDs are further configured to perform an action that is selected from a group consisting of: turning on the LEDs, turning off the LEDs, dimming the LEDs, brightening the LEDs, and changing a color associated with the LEDs.

19. The system of claim 17, wherein the power microprocessor is further configured to identify the code sequence including a plurality of “0s” and “1s,” wherein the “0s” are received when the voltage is received at the microprocessor and the “1s” are received in the information bits when the half cycles in the voltage are being suppressed.

20. The system of claim 17, wherein the plurality of LEDs are powered by the power microprocessor using a power link network.
